(19) United States
(12) Patent Application Publication
(10) Pub. No.: US 2026/0270980 A1
(43) Pub. Date: Sep. 10, 2026

(54) SCHEDULING REQUEST SHARING FOR HYBRID BEAMFORMING

(71) Applicant: Telefonaktiebolaget LM Ericsson (publ), Stockholm (SE)

(72) Inventors: Magnus Hurd, Stockholm (SE); Zhiming Yin, Danderyd (SE)

(21) Appl. No.: 18/869,382

(22) PCT Filed: Jun. 6, 2022
(86) PCT No.: PCT/EP2022/065299

§ 371 Date: Nov. 26, 2024

(51) Int. Cl. H04W 72/1263; H04B 7/06

(52) U.S. Cl. CPC H04W 72/1263; H04B 7/06952

(57) ABSTRACT

Please replace the Abstract with the following replacement Abstract:

Systems and methods for sharing resources for transmitting scheduling requests among two or more User Equipments (UEs) are provided. In one embodiment, a method performed by a base station comprises selecting one analog beam to use to monitor for a Scheduling Request (SR) on an SR occasion. The method further comprises monitoring the set of SR resources in the SR occasion on the one analog beam. The method further comprises, while monitoring the set of SR resources in the SR occasion, detecting one SR on the shared SR resource shared by the two or more UEs and sending a response to one UE of the two or more UEs. In this way, frequency and time resources are saved and latencies in data communications become shorter between the base stations and the UEs.

### TECHNICAL FIELD

The present disclosure is directed to systems and methods for sharing resources for transmitting scheduling requests among two or more User Equipments (UEs) in hybrid beamforming.

### BACKGROUND

High band deployment in Third Generation Partnership Project (3GPP) is referred to as deployment on frequencies higher than 6 GHz. To cope with the coverage challenge at higher frequencies, more antenna elements are needed. In New Radio (NR), the notion of massive antenna arrays has been introduced to achieve both increased coverage and an increased level of throughput. These antenna arrays are sometimes referred to as Advanced Antenna Systems (AAS). In 3GPP, the AAS is referred to as a Transmission/Reception Point (TRP) and is simply a collection of antenna elements, like a panel of elements. To reduce the cost of AAS, analog beamforming is used. Also, at the UE side, analog beamforming is expected at a high band, which means that the UE receives a transmission only from one beam at a time since its spatial reception filter applies to all resource elements of an Orthogonal Frequency-Division Multiplexing (OFDM) symbol (per polarization).

Analog beamforming is an example of time-domain beamforming, which means that one beamform applies to all frequency resources being parts of a transmission from the base station. Hybrid beamforming based on different sub-arrays of antenna elements connected to separate Radio Frequency (RF) chains is another version of time-domain beamforming. Compared to strict digital beamforming, hybrid beamforming can be seen as the digital domain operating an array of subarrays of antennas, as shown in FIG. 1. The subarrays of antennas are subject to analog beamforming and act as physical antennas, except that each of the beamforms of the subarrays can be pointing into different directions given appropriate beamforming weights for a specific point in time. In the present disclosure, these sub-arrays are referred to as ‘analog antenna subarrays.’

Theoretically, the analog beamforms of the analog antenna subarrays can point into different directions. However, a typical deployment of AAS would have these beamforms targeting similar directions, as shown in FIG. 1. This translates into beamforming weights that are the same (or close to) for the different analog antenna subarrays that the digital domain operates (typically coordinating the different subarrays to form a phased array). This should not be too surprising: a strict digital system connected to an array of physical antennas would generally utilize antennas with identical beamforms, not different antennas with beamforms pointing in different directions, simply to more easily coordinate the beamforms of the individual antennas. This means that this variant of hybrid beamforming executes digital beamforming within one analog beamform created by the analog antenna subarrays at a time. In other words, the digital beamforming part of hybrid beamforming can create a grid of narrow beams pointing along the direction of an analog beam.

Compared to a full digital solution, this approach of hybrid beamforming reduces the need to transfer data between the frontend and baseband. Another strategy to minimize data transfer between the baseband and the (analog) frontend, which is illustrated in FIG. 1, is to limit the number of layers allowed at a specific time occasion. A third strategy is only to receive data on a fraction of the full bandwidth. For some physical signals and (control) channels defined in 3GPP, this is actually good enough, allowing the base station to spatially resolve the received signal from the grid of all elements (on a reduced bandwidth). However, this means resources in the frequency domain are challenged.

An example of a control channel in NR is Physical Uplink Control Channel (PUCCH) (see 3GPP TS 38.211, version 17.1.0, “NR; Physical channels and modulation (Release 17),” 2022-04.) Among other things, it is responsible for carrying a Scheduling Request (SR). The UE would transmit this request whenever it has uplink data to transmit but no resources to transmit on. Typically, each admitted UE would be assigned a specific resource for transmitting an SR. Without an assigned resource for transmitting an SR, the UE would resort to random access whenever the UE needs uplink resources.

Whereas it is possible to append an SR onto, for instance, Hybrid Automatic Repeat Request (HARQ) Ack/Nack feedback on PUCCH, the network (e.g., the base station) cannot assume this opportunity being frequent enough to serve the UEs properly. Therefore, dedicated SR resources can be defined in, e.g., PUCCH format 0.

Each UE is configured with a Resource Block (RB) and a cyclic shift. Up to 12 UEs can share an RB, given that they are assigned different cyclic shifts. The cyclic shift is a way to share a range of subcarriers: a sequence of complex phases is applied to the subcarriers (as a function of the subcarrier index); each UE would have different sequences (loosely referred to as different cyclic shifts) to share the frequency resources.

### SUMMARY

Systems and methods for sharing resources for transmitting scheduling requests (SRs) among two or more User Equipments (UEs) in hybrid beamforming are provided. In one embodiment, a method performed by a base station comprising a hybrid beamforming antenna system comprises selecting one of a plurality of analog beams to use to monitor for an SR on an SR occasion. The SR occasion comprises a set of SR resources comprising a shared SR resource shared by two or more UEs. The method further comprises monitoring the set of SR resources in the SR occasion on the selected one of the plurality of analog beams. The method further comprises, while monitoring the set of SR resources in the SR occasion, detecting at least one SR on the shared SR resource shared by the two or more UEs and sending a response to at least one UE of the two or more UEs in response to detecting the at least one SR on the shared SR resource shared by the two or more UEs. In this way, frequency and time resources are saved, and latencies in data communications become shorter between the base stations and the UEs.

In one embodiment, a method performed by a base station comprising a hybrid beamforming antenna system comprises selecting a first SR configuration to use to monitor for an SR in a first SR occasion from among two or more SR configurations, each associated to a different one of a plurality of analog beams. The first SR configuration defines a set of SR resources for the first SR occasion. The set of SR resources comprises a shared SR resource that is shared by two or more UEs. The method further comprises monitoring the set of SR resources in the SR occasion in accordance with the first SR configuration in one of the plurality of analog beams associated to the first SR configuration. The method further comprises, while monitoring the set of SR resources in the one of the plurality of analog beams associated to the first SR configuration and detecting an SR on the shared SR resource that is shared by the two or more UEs. The method further comprises sending a response to at least one UE of the two or more UEs in response to detecting the SR on the shared SR resource that is shared by the two or more UEs.

In one embodiment, a method performed by a UE communicating with a base station comprising a hybrid beamforming antenna system, comprises transmitting, to a base station, an SR in an SR resource in an SR occasion. The SR resource is a shared SR resource that is shared by the UE and at least one additional UE in accordance with an SR configuration. The method further comprises receiving, from the base station, a grant that corresponds to the SR. The method further comprises transmitting, to the base station, uplink data.

In one embodiment, a method performed by a UE communicating with a base station comprising a hybrid beamforming antenna system comprises receiving, from the base station, a message that responds to an SR detected by the base station. The SR was detected by the base station in an SR resource that is shared by the UE and one or more additional UEs in accordance with an SR configuration, and was not transmitted by the UE. The method further comprises ignoring the message and not transmitting, to the base station, uplink data.

Corresponding embodiments of a base station and a UE are also disclosed.

In one embodiment, a base station (comprising a hybrid beamforming antenna system) is adapted to select one of a plurality of analog beams to use to monitor for an SR on an SR occasion. The SR occasion comprises a set of SR resources comprising a shared SR resource that is shared by two or more UEs. The base station is further adapted to monitor the set of SR resources in the SR occasion on the selected one of the plurality of analog beams. While monitoring the set of SR resources in the SR occasion, the base station is further adapted to detect at least one SR on the shared SR resource shared by the two or more UEs and send a response to at least one UE of the two or more UEs in response to detecting the at least one SR on the shared SR resource shared by the two or more UEs.

In one embodiment, a base station comprising a hybrid beamforming antenna system and processing circuitry is configured to cause the base station to select one of a plurality of analog beams to use to monitor for an SR on an SR occasion. The SR occasion comprises a set of SR resources comprising a shared SR resource that is shared by two or more UEs. The processing circuitry is further configured to cause the base station to monitor the set of SR resources in the SR occasion on the selected one of the plurality of analog beams. While monitoring the set of SR resources in the SR occasion, the processing circuitry is further configured to cause the base station to detect at least one SR on the shared SR resource shared by the two or more UEs. The processing circuitry is further configured to cause the base station to send a response to at least one UE of the two or more UEs in response to detecting the at least one SR on the shared SR resource shared by the two or more UEs.

In one embodiment, a base station (comprising a hybrid beamforming antenna system) is adapted to select a first SR configuration to use to monitor for an SR in a first SR occasion from among two or more SR configurations. Each SR configuration is associated to a different one of a plurality of analog beams. The first SR configuration defines a set of SR resources for the first SR occasion, the set of SR resources comprising a shared SR resource that is shared by two or more User Equipments. The base station is further adapted to monitor the set of SR resources in the SR occasion in accordance with the first SR configuration in one of the plurality of analog beams associated to the first SR configuration. While monitoring the set of SR resources in the one of the plurality of analog beams associated to the first SR configuration, the base station is further adapted to detect an SR on the shared SR resource that is shared by the two or more UEs and send a response to at least one UE of the two or more UEs in response to detecting the SR on the shared SR resource that is shared by the two or more UEs.

In one embodiment, a base station comprising a hybrid beamforming antenna system and processing circuitry is configured to cause the base station to select a first SR configuration to use to monitor for an SR in a first SR occasion from among two or more SR configurations. Each of the SR configurations is associated to a different one of a plurality of analog beams. The first SR configuration defines a set of SR resources for the first SR occasion and the set of SR resources comprises a shared SR resource that is shared by two or more UEs. The processing circuitry is configured to cause the base station to monitor the set of SR resources in the SR occasion in accordance with the first SR configuration in one of the plurality of analog beams associated to the first SR configuration. While monitoring the set of SR resources in the one of the plurality of analog beams associated to the first SR configuration, the processing circuitry is configured to cause the base station to detect an SR on the shared SR resource that is shared by the two or more UEs and send a response to at least one UE of the two or more UEs in response to detecting the SR on the shared SR resource that is shared by the two or more UEs.

In one embodiment, a UE (communicating with a base station comprising a hybrid beamforming antenna system) is adapted to transmit, to a base station, an SR in an SR resource in an SR occasion. The SR resource is a shared SR resource that is shared by the UE and at least one additional UE, in accordance with an SR configuration. The UE is further adapted to receive, from the base station, a grant that corresponds to the SR and transmit, to the base station, uplink data.

In one embodiment, a UE (communicating with a base station comprising a hybrid beamforming antenna system) is adapted to receive, from the base station, a message that responds to an SR detected by the base station. The SR was detected by the base station in an SR resource that is shared by the UE and one or more additional UEs in accordance with an SR configuration, and was not transmitted by the UE. The UE is further adapted to ignore the message and not transmit, to the base station, uplink data.

In one embodiment, a UE comprises one or more transmitters, one or more receivers, and processing circuitry associated with the one or more transmitters and the one or more receivers. The processing circuitry is configured to cause the UE to transmit, to a base station, an SR in an SR resource in an SR occasion. The SR resource is a shared SR resource that is shared by the UE and at least one additional UE, in accordance with an SR configuration. The processing circuitry is further configured to cause the UE to receive, from the base station, a grant that corresponds to the SR and transmit, to the base station, uplink data.

In one embodiment, a UE comprises one or more transmitters, one or more receivers, and processing circuitry associated with the one or more transmitters and the one or more receivers. The processing circuitry is configured to cause the UE to receive, from the base station, a message that responds to an SR detected by the base station. The SR was detected by the base station in an SR resource that is shared by the UE and one or more additional UEs in accordance with an SR configuration and was not transmitted by the UE. The processing circuitry is further configured to cause the UE to ignore the message and not transmit, to the base station, uplink data.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a hybrid beamforming system.

FIG. 2 illustrates one example of a cellular communications system according to some embodiments of the present disclosure.

FIG. 3 illustrates that two User Equipments (UEs) are configured to share a Scheduling Request (SR) resource in an uplink slot.

FIG. 4 illustrates a deployment with two analog beams in which two UEs are configured to share an SR resource.

FIG. 5 illustrates that two UEs transmit their SRs to the base station on narrow beams within an analog beam.

FIG. 6 illustrates one example of steps performed by the base station and the UEs in accordance with the embodiments of the present disclosure.

FIG. 7 illustrates that two different SR configurations for two different analog beams are used for the UEs.

FIG. 8 illustrates another example of steps performed by the base station and the UEs in accordance with the embodiments of the present disclosure.

FIG. 9 is a schematic block diagram of a radio access node according to some embodiments of the present disclosure.

FIG. 10 is a schematic block diagram that illustrates a virtualized embodiment of the radio access node of FIG. 9 according to some embodiments of the present disclosure.

FIG. 11 is a schematic block diagram of the radio access node of FIG. 9 according to some other embodiments of the present disclosure.

FIG. 12 is a schematic block diagram of a UE device according to some embodiments of the present disclosure.

FIG. 13 is a schematic block diagram of the UE of FIG. 12 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

### Wireless Communication Device: One Type of Communication Device Is a

wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP. As stated above, in 3GPP, the AAS may be referred to as a TRP and is simply a collection of antenna elements, like a panel of elements.

In some embodiments, a set of Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

A receiver only using a part of the bandwidth may not be able to serve physical signals and control channels for many users in one time occasion.

An SR (Scheduling Request) resource assigned to a user consists of both a resource block (RB) and a cyclic shift (defined within that RB). If many users shall be assigned SR resources in one symbol, the frequency resources may not be enough if the base station used a digital receiver with low-bandwidth capacity.

The present disclosure is directed to systems and methods for sharing a frequency resource (RB together with a cyclic shift) among two or more UEs. Whenever an SR is received by the base station on such a shared resource, the base station may respond with a Physical Downlink Control Channel (PDCCH) to each of the users assigned the shared resource. The users not having requested any uplink resources may simply ignore the assignment of uplink resources in PDCCH. The selection of users to respond to may be based on which direction the power of the SR transmission originated from.

Advantages of the present disclosures are, for example, saving frequency and time resources and having shorter latencies in data communications between the base stations and the UEs.

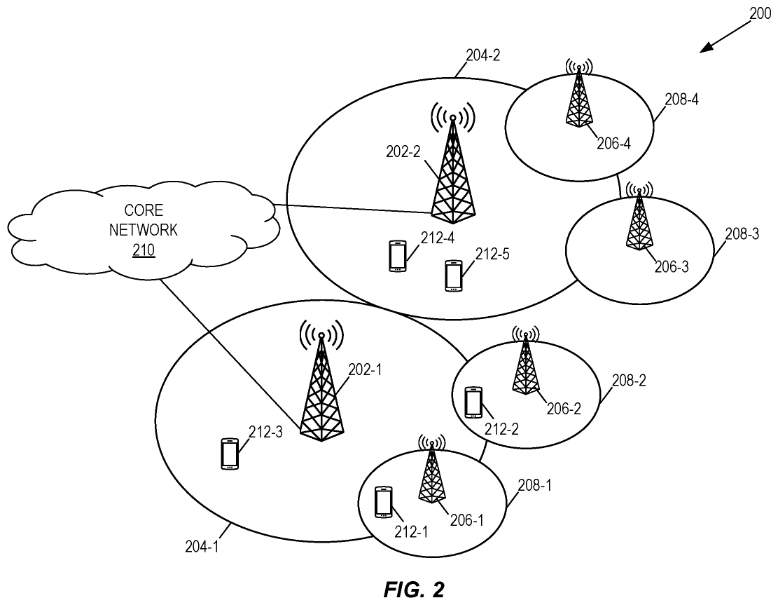

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 202-1 and 202-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication devices 212. In the following description, the wireless communication devices 212 are oftentimes UEs, but the present disclosure is not limited thereto.

In embodiments of the present disclosure, two or more UEs 212 are configured with the same SR resource. In other words, the two or more UEs are all assigned the same RB as well as the same cyclic shift (for example, “initialCyclicShift,” in 3GPP TS 38.331, version 17.0.0, “NR; Radio Resource Control (RRC) protocol specification (Release 17),” 2022-04). The SR resource can be based on PUCCH format 0 or other format that may be shared. The UE is informed about the SR resource by means of signaling from the network such as, e.g., RRC configuration (see also 3GPP TS 38.331, version 17.0.0, “NR; Radio Resource Control (RRC) protocol specification (Release 17),” 2022-04), which may be transmitted from a base station 202 to the UE 212. This signaling may additionally include an indication via Medium Access Control (MAC) Control Element (CE) to switch between already configured SR configurations, which may be transmitted from a base station 202 to the UE 212.

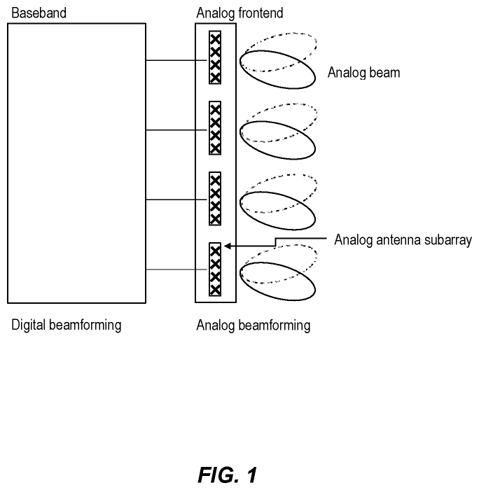

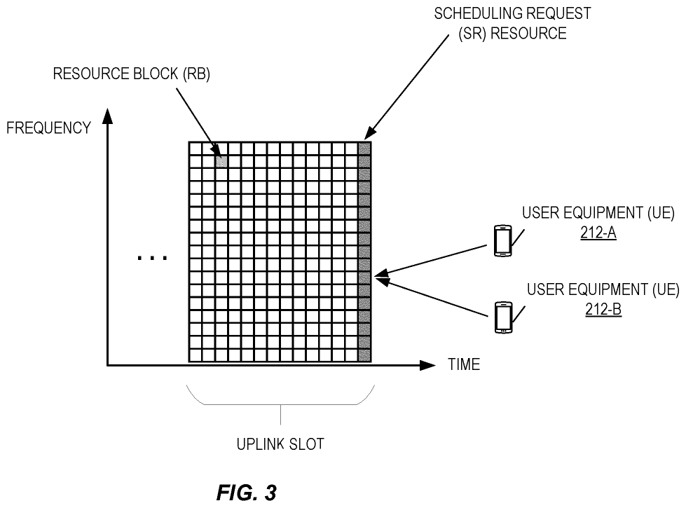

As shown in FIG. 3, there could be many SR resources defined in an uplink slot; each RB can accommodate up to twelve (12) SR resources (according to format 0), each one with a specific cyclic shift. The present disclosure addresses a scenario when even this many SR resources are not enough either because there are too many UEs 212 or because there is some other restriction on how many SR resources can actually be configured. One such restriction could, in milli-meter Wave (mmW), be a specialized receiver only receiving digitally on a subset of the total amount of RBs in the scope of the deployment. It could, for instance, be that the receiver receives only over a reduced range of bandwidth (fewer RBs) over only a few symbols in one batch, receiving samples from all analog antenna subarrays (see FIG. 1) for the base station 202 to perform digital beamforming in baseband.

In FIG. 3, two UEs 212 (denoted as UE 212-A and UE 212-B) are configured to share an SR resource. The SR resources are only shown in FIG. 3 for one uplink slot, and the slots containing SR resources are repeated at some periodicity. Within an RB, the UEs 212 assigned to that RB can be assigned different cyclic shifts or equal cyclic shifts. If the cyclic shifts are equal, then the two UEs 212 share the SR resource.

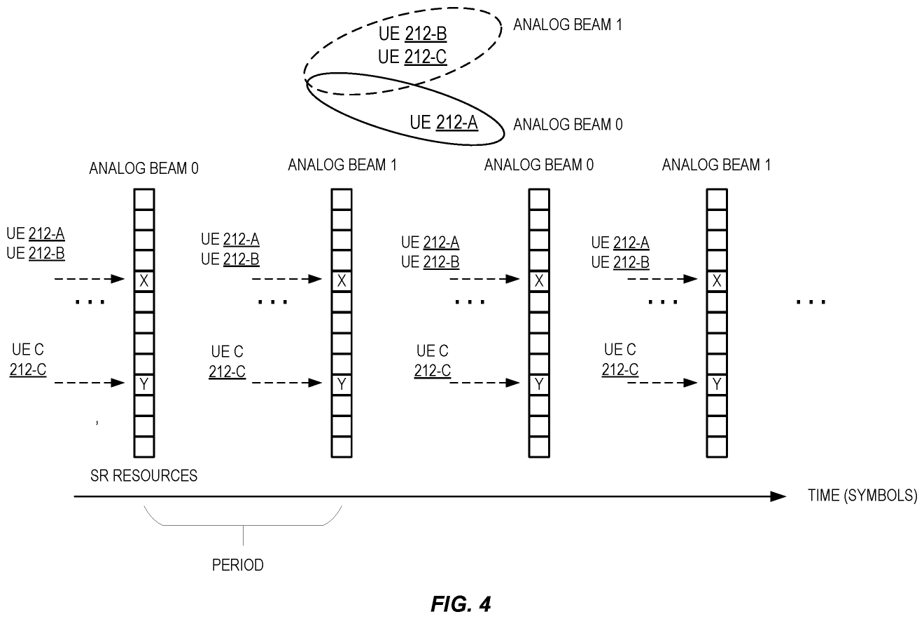

The procedure to handle transmission on such a shared SR resource is described as follows. Note that this procedure is valid for one analog beam direction. For another analog beam direction, there will be another set of SR resources defined in another symbol, as shown in FIG. 4. This is the nature of analog beamforming, transmission can only happen in one analog beamform at a time and, within that analog beamform, digital beamforming can be performed.

FIG. 4 illustrates a one example embodiment with two analog beams (“analog beam 0” and “analog beam 1”) to cover the service area. It is preferable to allocate UEs 212 on a shared resource when they are located in different analog beams. In FIG. 4, the assignment of UEs 212-A, 212-B, and 212-C to SR resources are shown. UEs 212-A and 212-B share the same SR resource (i.e., are assigned to a shared SR resource), which is denoted in FIG. 4 as SR resource X. In contrast, UE 212-C is assigned to a different SR resource, which is denoted in FIG. 4 as SR resource Y.

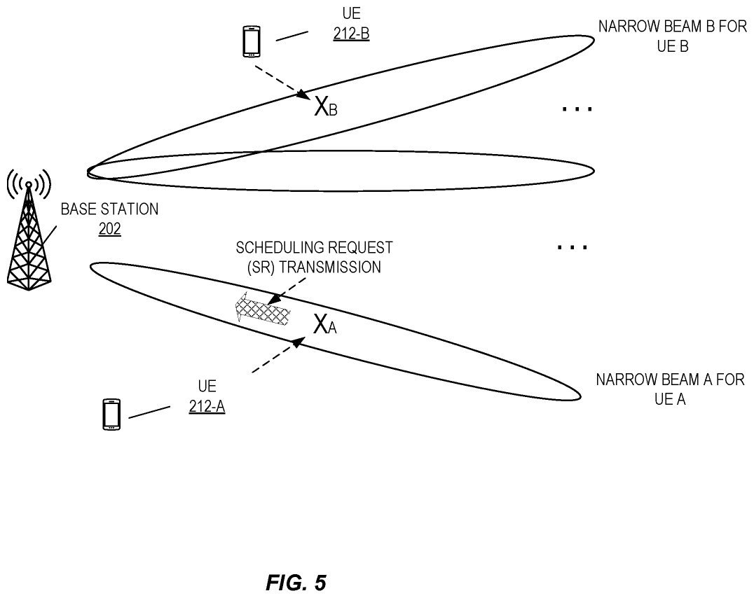

It is assumed that the base station 202 keeps track of the whereabouts of all the UEs 212. In other words, the base station 202 maintains an association to a (narrow) beam (like the beams of FIG. 5) for all the UEs 212 in the cell. This beam management can be based on sounding transmitted by the UE or on Channel State Information Reference Signal (CSI-RS) transmitted by the base station 202.

First, the base station 202 receives energy above a threshold on a shared SR resource defined by a combination of an RB and a cyclic shift. A digital receiver is prepared to receive energy above a threshold on all the SR recourses concurrently in one symbol and for all narrow beams (in the direction of one analog beam). The digital receiver is for hybrid beamforming applied in one analog beam direction at a time. For a shared SR resource (e.g., the shared SR resource X of FIG. 4), there are two or more assigned UEs 212 (e.g., UEs 212-A and 212-B assigned to the shared SR resource X in FIG. 4). The receiver will beamform the received signal according to what beams are currently applicable for the UEs 212 that are assigned to the shared SR resource (as maintained by beam management). In other words, as shown in FIG. 4, in a first SR occasion (i.e., a first OFDM symbol), the base station 202 monitors a set of SR resources on that SR occasion while beamforming the received signal in the direction of analog beam 0, which is the direction in which UE 212-A is located. Then, in a second SR occasion (i.e., a second OFDM symbol), the base station monitors the set of SR resources on that SR occasion while beamforming the received signal in the direction of analog beam 1, which is the direction in which UE 212-B is located. In this way, the base station 202 can conclude what UE(s) 212 were issuing the SR. For instance, if energy above a threshold is detected in the shared SR resource X in the first SR occasion, the base station 202 can conclude that the UE 212-A transmitted the SR. Conversely, if energy above a threshold is detected in the shared resource X in the second SR occasion, the base station 202 can conclude that the UE 212-B transmitted the SR.

In FIG. 5, two UEs 212 (‘UE 212-A’ and ‘UE 212-B’) share an SR resource. One of them, UE 212-A, transmits an SR to the base station 202. In the context of hybrid beamforming, the (narrow) beam of UE 212-A used for reception of the SR shall be seen to happen within one analog beam.

Next, the base station 202 formulates a response to the SR. Such a response may comprise a scheduling resource on PDCCH. The intention of the scheduling response to the UE 212-A is to provide uplink resources (e.g., Physical Uplink Shared Channel (PUSCH)) such that uplink data (e.g., a buffer status report (BSR)) can be transmitted; only then the base station 202 can know details about the amount of uplink resources that the UE 212-A needs. Based on reciprocity, the response can be in a downlink beamform compatible with the beam on which the SR was received.

Both PDCCH and PUSCH are user-specific, so there is no sharing aspect of the response. In one embodiment, the base station 202 responds to every UE 212 configured with the shared SR resource, also to the UEs 212 that did not transmit on the SR resource at this particular instance. That is, when a UE 212, which did not transmit an SR to the base station 202, receives such a response from the base station 202, the UE 212 simply ignores the response (for example, the PUSCH assignment in the detected PDCCH, according to the settings of skipUplinkTxDynamic or enhancedSkipUplinkTxDynamic (set as true) as stated in 3GPP TS 38.331). This approach would be an accurate strategy, serving all potential UEs 212. However, this would not be resource-efficient since both PDCCH and PUSCH resources are allocated regardless of the UEs 212 transmitting an SR. To reduce the number of false responses, one can apply a strategy of sharing SR only between the UEs 212 from different analog beams if possible (as shown in FIG. 4). This strategy can only reduce the number of false responses to some degree since the UE can move to the same analog beam as its companion sharing the SR.

However, as previously stated, beam management has a clear view of the beam applicable for a UE 212, both in terms of which analog beam and in terms of which narrow beam (within the applicable analog beam) the UE is associated with. This can be used to only respond to those UEs 212 (of the ones subscribed to the shared SR resource) that according to beam management are compatible with the analog beam and the narrow beam within the analog beam on which the SR was received. This would be a resource-efficient strategy with some risk of not serving all UEs 212 transmitting an SR if beam management, for some reason, is not accurate. Such inaccurate beam management could be a result of the UE 212 not transmitting sounding frequently enough. For such a UE 212, the base station 202 could apply a number of extra narrow beams adjacent to the beam that has been registered as the current beam for the UE Q112. If a UE 212 transmits SRs to the base station 202, but those SRs are consistently not served by the base station 202, the UE 212 would, in one embodiment, resort to random access after a certain number of transmitted (but not served) SRs.

SR transmissions, e.g., based on PUCCH format 0 from different UEs (sharing the SR resource), can be selected to be identical physical signals. The base station then perceives several UEs sharing SR resources transmitting the SR as receiving several copies of the same signal; thus, the received signal's strength is increased from the base station's point of view. This, in fact, means that the UEs can be seen to “collaborate” in telling the base station that some UEs have issued SR. If SR transmissions from different UEs sharing the SR resource were different, there would be an interference challenge for the base station (that could in many cases be mitigated by the use of narrow beams). An example of not identical signals would be if some UEs perform frequency hopping and some not.

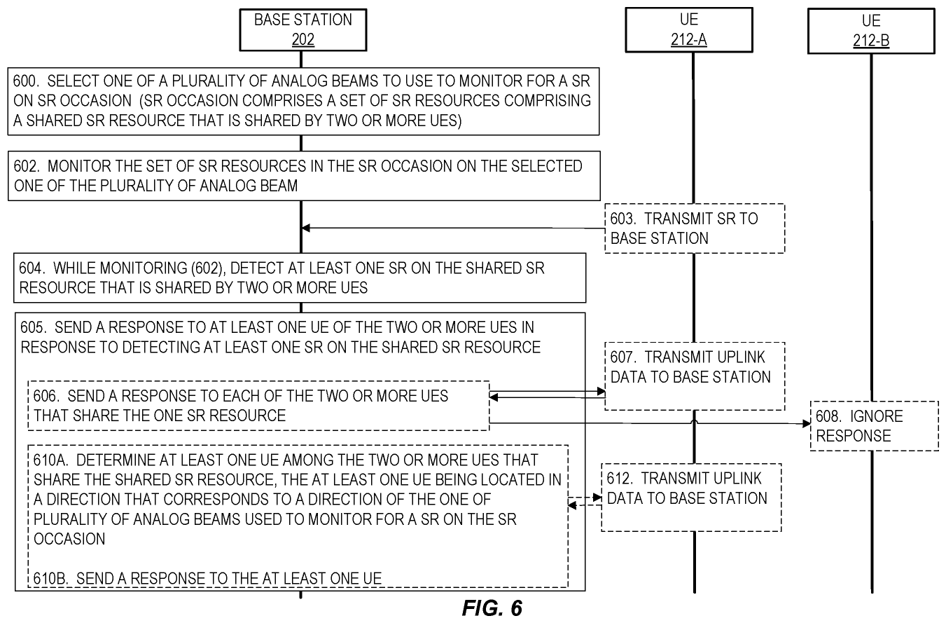

FIG. 6 illustrates one example of steps performed by the base station 202 and the UEs 212 in accordance with the embodiments of the present disclosure. Optional steps are represented by dashed lines/boxes. The procedure of FIG. 6 is one example of a procedure that can be performed when using an SR configuration such as that shown in the example of FIG. 4.

In step 600, the base station 202 selects one of a plurality of analog beams to use to monitor for an SR on an SR occasion that comprises a set of SR resources comprising a shared SR resource that is shared by two or more UEs 212. Note that the SR resources may be configured as described above with either FIG. 4 or FIG. 7.

In step 602, the base station 202 monitors the set of SR resources in the SR occasion on the selected one of the plurality of analog beams.

In optional step 603, one of the UEs, which in this example is UE 212-A, of the two or more UEs 212 assigned to the shared SR resource transmits its SR to the base station 202 on the shared SR resource.

In step 604, while monitoring the set of SR resources in the SR occasion, the base station 202 detects the SR on the shared SR resource.

In step 605, the base station 202 sends a response to at least one of the UE 212 assigned to the shared SR resource in response to the above step of detecting the SR on the shared SR resource. For example, the response sent by the base station 202 to the at least one UE may comprise a Physical Downlink Control Channel (PDCCH) comprising Downlink Control Information (DCI) scheduling resources on a Physical Uplink Shared Channel (PUSCH) for the transmission of a BSR. In one embodiment, the base station 202 sends the response to each of the two or more UEs 212 that share the shared SR resource or each of the two or more UEs 212 that share the shared SR resource and are located in the analog beam direction used for receiving the signal at the base station 202 (step 606). In response, the UE 212-A transmits uplink data (e.g., a BSR) to the base station 202 (step 607). Meanwhile, the UE 212-B ignores the received response because the UE 212-B is not a UE transmitting the SR to the base station 202 (step 608).

In another embodiment, the base station 202 determines at least one UE 212 among the two or more UEs 212 that share the shared SR resource that according to beam management is located in a narrow beam compatible with the beam (both analog and digital narrow beam) on which the SR was received (step 610A). The base station sends the response to these UEs 212 only (step 610B). In response, the UE 212-A may transmit its uplink data (e.g., a BSR) to the base station 202 (step 612). The base station 202 may repeat the above steps for next (second, third,.) SRs on next SR occasions.

FIG. 7 illustrates another embodiment of the present disclosure in which there is a common SR configuration. As with the embodiment of FIG. 4, SR occasions repeat at some periodicity, and the base station 202 sweeps through the analog beams in a round-robin manner over the SR occasions). However, in the embodiment of FIG. 7, different SR configurations are used for different analog beam directions. In other words, each analog beam has a respective SR configuration. In this example, UE 212-A is assigned to an SR resource X in the SR configuration associated to analog beam 0, and UEs 212-B and 212-C are assigned to a shared SR resource Y in the SR configuration associated to analog beam 1.

In FIG. 7, two SR configurations aimed at different analog beams: the thick black lined configuration is for analog beam 0, the thin lined configuration is for beam 1. Typically (as shown in FIG. X4), only one common configuration can be used at a time for a UE 212. Therefore, the base station 202 reconfigures each UE 212 with the appropriate SR configuration each time the UE 212 switches analog beams. That is, the base station 202 will configure a UE 212 with an SR configuration applicable for a certain analog beam. If the UE 212 moves to another beam, the base station 202 reconfigures the UE 212 with the SR configuration applicable for the new beam. This reconfiguration may be done via dedicated signaling such as, e.g., RRC signaling.

The current 3GPP standards do not disclose methods to configure the UE 212 with, for example, two SR configurations and to have the UE 212 switch between the two SR configurations using, for instance, a MAC CE or a Downlink Control Information (DCI). In 3GPP TS 38.321, version 17.0.0, “NR; Medium Access Control (MAC) protocol specification,” 2022-04, section 5.4.4 states, “Each SR configuration corresponds to one or more logical channels and/or to SCell beam failure recovery and/or to consistent LBT failure recovery. Each logical channel, SCell beam failure recovery, and consistent LBT failure recovery may be mapped to zero or one SR configuration, which is configured by RRC. The SR configuration of the logical channel that triggered a BSR (clause 5.4.5) or the SCell beam failure recovery or the consistent LBT failure recovery (clause 5.21) (if such a configuration exists) is considered as corresponding SR configuration for the triggered SR. Any SR configuration may be used for an SR triggered by Pre-emptive BSR (clause 5.4.7).”

The important information in the above-reproduced section of 3GPP TS 38.321 is that only one SR configuration is allowed per one logical channel. Currently, there is no MAC CE message defined in 3GPP TS 38.321 that enables switching between two SR configurations.

The present disclosure proposes to support for more than one SR configuration. The present disclosure also proposes to introduce switching between two SR configurations based on MAC CE. Compared to the current 3GPP standards (for example, 3GPP TS 38.321), the proposed switching between two SR configurations by the way of MAC CE message would reduce the RRC signaling overhead when the UE switches analog beams for this alternative approach illustrated in FIG. 7.

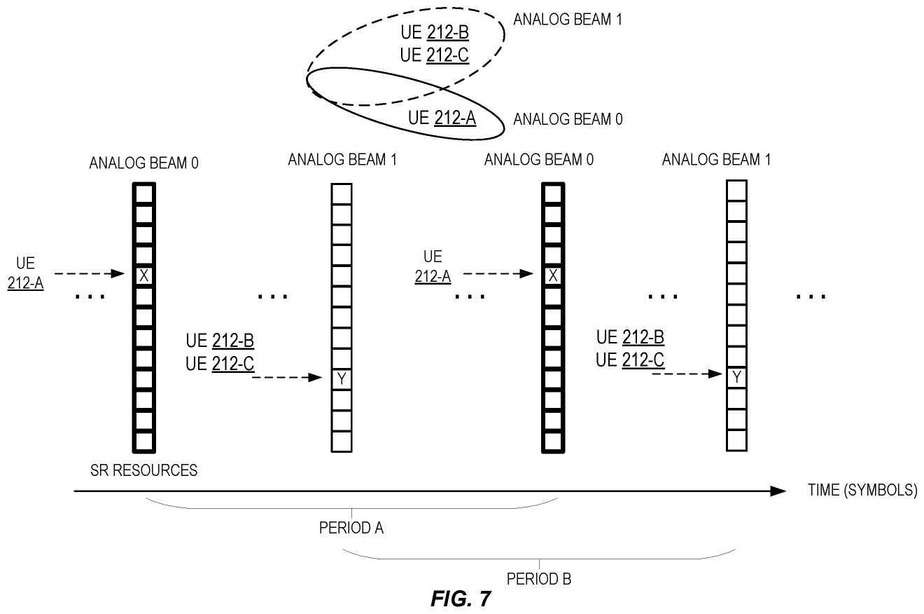

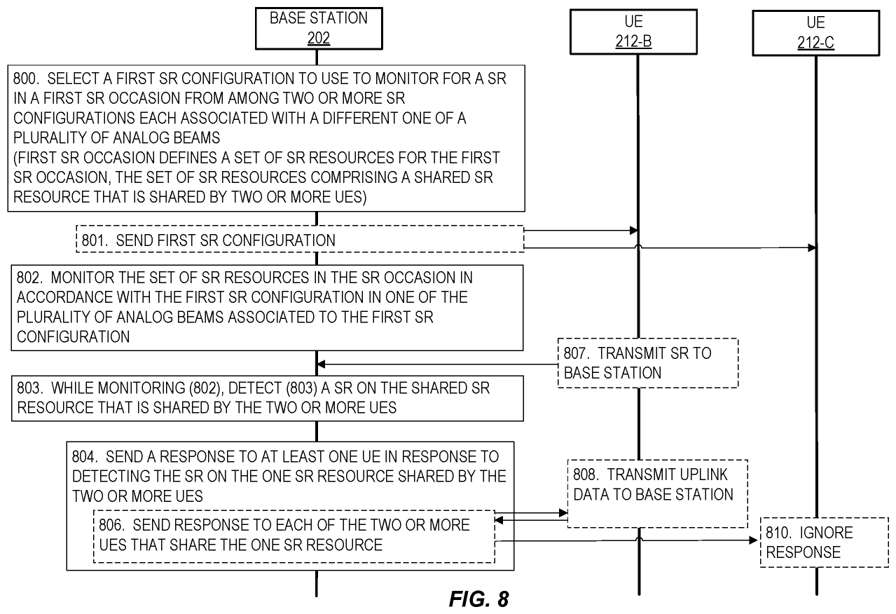

FIG. 8 illustrates another example of steps performed by the base station 202 and the UEs 212 in accordance with the embodiments of the present disclosure. Optional steps are represented by dashed lines/boxes. The procedure of FIG. 8 is one example of a procedure that can be performed when using an SR configuration such as that shown in the example of FIG. 7.

In step 800, the base station 202 selects, from among two or more SR configurations, a first SR configuration to use to monitor for an SR in a first SR occasion. Each of the two or more SR configurations is associated to a different one of a plurality of analog beams. The first SR configuration defines a set of SR resources for the first SR occasion. The set of SR resources comprises a shared SR resource that is shared by two or more UEs 212, which are UEs 212-B and 212-C in the example of FIG. 8 in a manner that is consistent with the example of FIG. 7.

In optional step 801, the base station 202 may send the selected first SR configuration to at least one UE of the two or more UEs 212. For example, the first SR configuration may be transmitted via an RRC reconfiguration message. Alternatively, the first SR configuration may be indicated to be activated via a MAC CE message assuming the first SR configuration (and other SR configurations for each analog beam) have previously been configured to the UE. For example, the first SR configuration is sent to the two or more UEs 212 in their respective directions to the plurality of analog beams of the base station 202. Note that step 801 may be performed prior to step 800. In step 802, the base station 202 monitors the set of SR resources in the SR occasion in accordance with the first SR configuration in one of the plurality of analog beams associated to the first SR configuration.

In step 807, optionally, the UE transmits an SR to the base station 202.

In step 803, while monitoring the set of SR resources in the one of the plurality of analog beams associated to the first SR configuration, the base station 202 detects an SR on the shared SR resource that is shared by the two or more UEs 212-B and 212-C.

In step 804, the base station 202 sends a response to at least one UE of the two or more UEs 212 in response to the above step of detecting the SR on the shared SR resource that is shared by the two or more UEs 212. In one embodiment, the base station 202 sends a response to each of the two or more UEs 212 (step 806). In response, the UE 212-B, which sent its SR to the base station 202, transmits uplink data (e.g., a BSR) to the base station 202 using a resource(s) granted by the response received in step 806 (step 808). Since the UE 212-C did not send an SR to the base station 202, the UE 212-C ignores the response (step 810). The base station 202 may repeat the above steps for the next (second, third,.) SR configurations in the next SR occasions.

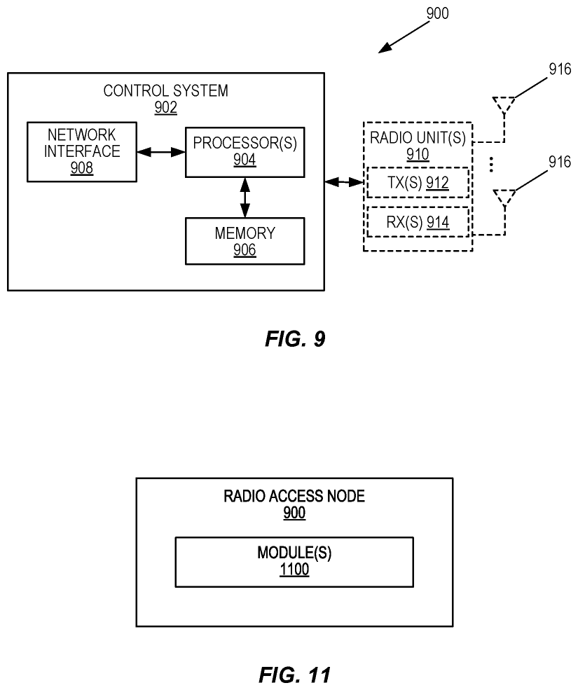

FIG. 9 is a schematic block diagram of a radio access node 900 according to some embodiments of the present disclosure. Optional features are represented by dashed boxes. The radio access node 900 may be, for example, a base station 202 or 206 or a network node that implements all or part of the functionality of the base station 202 or gNB described herein. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 may include the control system 902 and/or the one or more radio units 910, as described above. The control system 902 may be connected to the radio unit(s) 910 via, for example, an optical cable or the like. The radio access node 900 includes one or more processing nodes 1000 coupled to or included as part of a network(s) 1002. If present, the control system 902 or the radio unit(s) are connected to the processing node(s) 1000 via the network 1002. Each processing node 1000 includes one or more processors 1004 (e.g., CPUs, ASICs, FPGAS, and/or the like), memory 1006, and a network interface 1008.

In this example, functions 1010 of the radio access node 900 described herein are implemented at the one or more processing nodes 1000 or distributed across the one or more processing nodes 1000 and the control system 902 and/or the radio unit(s) 910 in any desired manner. In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

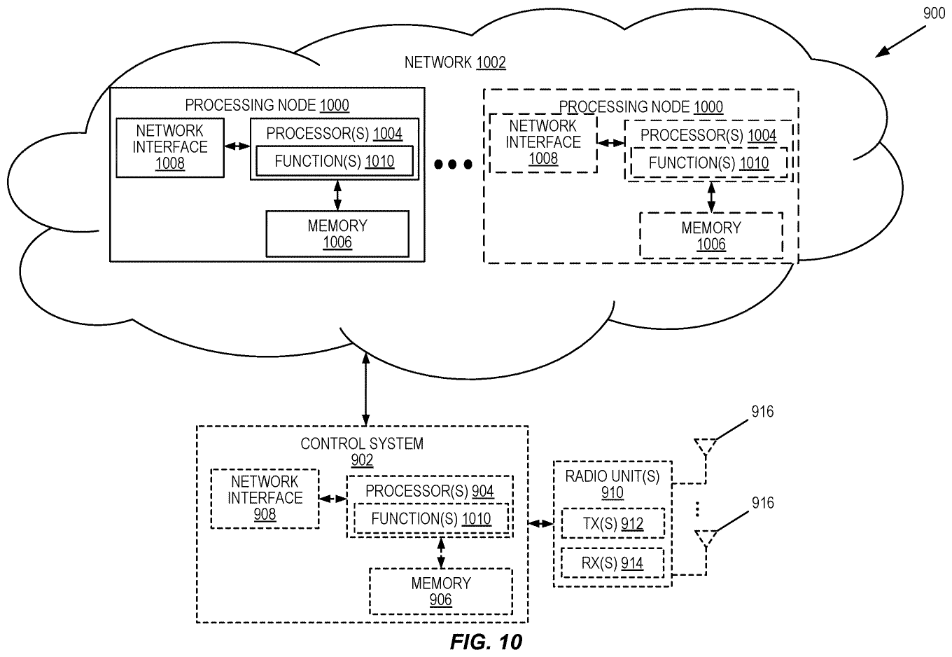

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

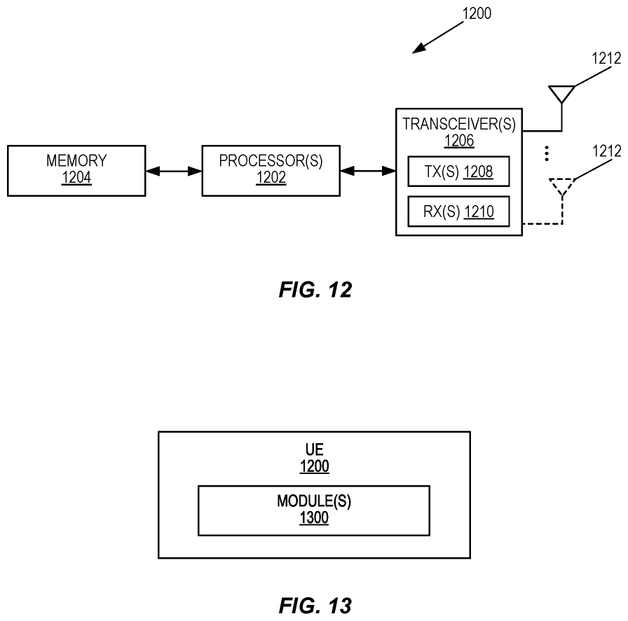

FIG. 12 is a schematic block diagram of a wireless communication device 1200 according to some embodiments of the present disclosure. As illustrated, the wireless communication device 1200 includes one or more processors 1202 (e.g., CPUs, ASICs, FPGAS, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry. The transceivers 1206 are also referred to herein as radio circuitry. In some embodiments, the functionality of the wireless communication device 1200 described above may be fully or partially implemented in software that is, e.g., stored in the memory 1204 and executed by the processor(s) 1202. Note that the wireless communication device 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the wireless communication device 1200 and/or allowing output of information from the wireless communication device 1200), a power supply (e.g., a battery and associated power circuitry), etc.

In some embodiments, a computer program including instructions which, when executed by at least one processor, causes the at least one processor to carry out the functionality of the wireless communication device 1200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the wireless communication device 1200 according to some other embodiments of the present disclosure. The wireless communication device 1200 includes one or more modules 1300, each of which is implemented in software. The module(s) 1300 provide the functionality of the wireless communication device 1200 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AAS Advanced Antenna Systems
AF Application Function
AMF Access and Mobility Function
AN Access Network
AP Access Point
ASIC Application Specific Integrated Circuit
AUSF Authentication Server Function
BSR Buffer Status Report
CE Control Element
CPU Central Processing Unit
CSI-RS Channel State Information Reference Signal
DCI Downlink Control Information
DN Data Network
DSP Digital Signal Processor
eNB Enhanced or Evolved Node B
EPC Evolved Packet Core
EPS Evolved Packet System
E-UTRA Evolved Universal Terrestrial Radio Access
FPGA Field Programmable Gate Array
gNB New Radio Base Station
gNB-DU New Radio Base Station Distributed Unit
HARQ Hybrid Automatic Repeat Request
HSS Home Subscriber Server
IOT Internet of Things
IP Internet Protocol
LTE Long Term Evolution
MAC Medium Access Control
MME Mobility Management Entity
MMW Milli-Meter Wave
MTC Machine Type Communication
NEF Network Exposure Function
NF Network Function
NG-RAN Next Generation Radio Access Network
NR New Radio
NRF Network Function Repository Function
NSSF Network Slice Selection Function
OFDM Orthogonal Frequency-Division Multiplexing
PC Personal Computer
PCF Policy Control Function
PDCCH Physical Downlink Control Channel
PDSCH Physical Downlink Shared Channel
P-GW Packet Data Network Gateway
PRS Positioning Reference Signal
PUCCH Physical Uplink Control Channel
PUSCH Physical Uplink Shared Channel
QoS Quality of Service
RAM Random Access Memory
RAN Radio Access Network
RB Resource Block RF Radio Frequency
ROM Read Only Memory
RP Reception Point
RRC Radio Resource Control
RRH Remote Radio Head
RTT Round Trip Time
SCEF Service Capability Exposure Function
SMF Session Management Function
SR Scheduling Request
TCI Transmission Configuration Indicator
TP Transmission Point
TRP Transmission/Reception Point
UDM Unified Data Management
UE User Equipment

Those skilled in the art will recognize improvements and modifications to the embodiments of the present disclosure. All such improvements and modifications are considered within the scope of the concepts disclosed herein.

1. A method performed by a base station comprising a hybrid beamforming antenna system, the method comprising:
selecting one of a plurality of analog beams to use to monitor for a Scheduling Request, SR, on an SR occasion, wherein the SR occasion comprises a set of SR resources comprising a shared SR resource that is shared by two or more User Equipments, UEs;
monitoring the set of SR resources in the SR occasion on the selected one of the plurality of analog beams;
while monitoring the set of SR resources in the SR occasion, detecting at least one SR on the shared SR resource shared by the two or more UEs; and
sending a response to at least one UE of the two or more UEs in response to detecting the at least one SR on the shared SR resource shared by the two or more UEs.

2. (canceled)

3. The method of claim 1, wherein detecting at least one SR on the shared SR resource shared by the two or more UEs comprises detecting two or more SRs on the shared SR resource, each SR of the two or more SRs being transmitted by each of the two or more UEs

4. The method of claim 1, wherein sending the response to at least one UE of the two or more UEs comprises sending the response to each of the two or more UEs that share the shared SR resource.

5. The method of claim 1, wherein sending the response to at least one UE of the two or more UEs comprises:
determining at least one UE among the two or more UEs that share the shared SR resource, the at least one UE being located in a direction that corresponds to a direction of the one of the plurality of analog beams used to monitor for an SR on the SR occasion; and
sending the response to the at least one UE in a direction compatible with the determined direction of the one of the plurality of analog beams.

6. The method of claim 1, further comprising:
selecting a second beam of the plurality of analog beams to use to monitor for a second Scheduling Request, SR, on a second SR occasion;
monitoring the set of SR resources in the second SR occasion on the selected second beam of the plurality of analog beams;
while monitoring the set of SR resources in the second SR occasion, detecting second SR on the shared SR resource shared by the two or more UEs; and
sending a second response to at least one UE of the two or more UEs in response to detecting the second SR on the second SR resource shared by the two or more UEs.

7. (canceled)

8. (canceled)

9. A method performed by a base station comprising a hybrid beamforming antenna system, the method comprising:
selecting a first Scheduling Request, SR, configuration to use to monitor for a Scheduling Request, SR, in a first SR occasion from among two or more SR configurations, each associated to a different one of a plurality of analog beams, wherein the first SR configuration defines a set of SR resources for the first SR occasion, the set of SR resources comprising a shared SR resource that is shared by two or more User Equipments, UEs;
monitoring the set of SR resources in the SR occasion in accordance with the first SR configuration in one of the plurality of analog beams associated to the first SR configuration;
while monitoring the set of SR resources in the one of the plurality of analog beams associated to the first SR configuration, detecting an SR on the shared SR resource that is shared by the two or more UEs; and
sending a response to at least one UE of the two or more UEs in response to detecting the SR on the shared SR resource that is shared by the two or more UEs.

10. The method of claim 9, further comprising sending the selected first SR configuration to the two or more UEs that, known by the base station, sending the selected SR configuration to the two or more UEs in their respective directions to the plurality of analog beams of the base station.

11. (canceled)

12. (canceled)

13. The method of claim 9, wherein sending the response to at least one UE of the two or more UEs comprises sending the response to each of the two or more UEs that share the shared SR resource.

14-18. (canceled)

19. A method performed by a User Equipment, UE, communicating with a base station comprising a hybrid beamforming antenna system, the method comprising:
transmitting to a base station a Scheduling Request, SR, in an SR resource in an SR occasion, the SR resource being a shared SR resource that is shared by the UE and at least one additional UE, in accordance with an SR configuration;
receiving from the base station, a grant that corresponds to the SR; and
transmitting, to the base station, uplink data.

20. A method performed by a User Equipment, UE, communicating with a base station comprising a hybrid beamforming antenna system, the method comprising:
receiving, from the base station a message that responds to a Scheduling Request, SR detected by the base station, wherein the SR was detected by the base station in an SR resource that is shared by the UE and one or more additional UEs, in accordance with an SR configuration, and was not transmitted by the UE; and
ignoring the message and not transmitting, to the base station, uplink data.

21. (canceled)

22. (canceled)

23. A base station comprising a hybrid beamforming antenna system, the base station adapted to:
select one of a plurality of analog beams to use to monitor for a Scheduling Request, SR, on an SR occasion, wherein the SR occasion comprises a set of SR resources comprising a shared SR resource that is shared by two or more User Equipments, UEs;
monitor the set of SR resources in the SR occasion on the selected one of the plurality of analog beams;
while monitoring the set of SR resources in the SR occasion, detect at least one SR on the shared SR resource shared by the two or more UEs; and
send a response to at least one UE of the two or more UEs in response to detecting the at least one SR on the shared SR resource shared by the two or more UEs.

24-26. (canceled)

27. A base station comprising a hybrid beamforming antenna system, the base station adapted to:
select a first Scheduling Request, SR, configuration to use to monitor for a Scheduling Request, SR, in a first SR occasion from among two or more SR configurations, each associated to a different one of a plurality of analog beams, wherein the first SR configuration defines a set of SR resources for the first SR occasion, the set of SR resources comprising a shared SR resource that is shared by two or more User Equipments, UEs;
monitor the set of SR resources in the SR occasion in accordance with the first SR configuration in one of the plurality of analog beams associated to the first SR configuration;
while monitoring the set of SR resources in the one of the plurality of analog beams associated to the first SR configuration, detect an SR on the shared SR resource that is shared by the two or more UEs; and
send a response to at least one UE of the two or more UEs in response to detecting the SR on the shared SR resource that is shared by the two or more UEs.

28-30. (canceled)

31. A User Equipment, UE, communicating with a base station comprising a hybrid beamforming antenna system, adapted to:
transmit, to a base station, a Scheduling Request, SR, in an SR resource in an SR occasion, the SR resource being a shared SR resource that is shared by the UE and at least one additional UE, in accordance with an SR configuration;
receive, from the base station a grant that corresponds to the SR; and
transmit, to the base station, uplink data.

32. A User Equipment, UE, communicating with a base station (202) comprising a hybrid beamforming antenna system, adapted to:
receive, from the base station a message that responds to a Scheduling Request, SR detected by the base station, wherein the SR was detected by the base station in an SR resource that is shared by the UE and one or more additional UEs, in accordance with an SR configuration, and was not transmitted by the UE; and
ignore the message and not transmit, to the base station, uplink data.

33-36. (canceled)
